(19) United States
(12) Patent Application Publication
(10) Pub. No.: US 2008/0168678 A1
(43) Pub. Date: Jul. 17, 2008

(54) Pedestal dryer vent

(76) Inventor: Kevin R. Menlove, Bountiful, UT (US)

Correspondence Address: RESEARCH PUBLICATIONS, LLC, 2767 S. IRENE DR., BOUNTIFUL, UT, 84010, US

(21) Appl. No.: 11/652,986

(22) Filed: Jan. 11, 2007

(51) Int. Cl. F26B 3/04

(52) U.S. Cl. 34/235; 248/678; 34/476

(57) ABSTRACT

A pedestal dryer vent passes the dryer vent hose through the pedestal, allowing the dryer to be placed close to a wall and reducing the opportunity for kinks or obstructions in the vent hose.

### BACKGROUND OF THE INVENTION

1. The Field of the Invention

The present invention relates to an improved dryer vent. More specifically, the present invention relates to a dryer vent which reduces or eliminates the space between the dryer and the wall, and which reduces the chance of a kink in the flexible dryer vent hose.

2. State of the Art

Clothes dryers are typically vented to the outside of a house. Such an arrangement is advantageous as the exhaust air from the dryer, which typically carries a fair amount of lint, is expelled from the house. The dryer exhaust vent exits from the back of the dryer, and is typically connected to a section of flexible hose, which is in turn connected to a vent pipe in the house wall. The vent pipe extends to a point outside of the house.

One of the disadvantages of such an arrangement is that the dryer can not be pushed back against the wall. The flexible vent hose necessitates a space between the dryer and the wall. If the dryer is pushed back too far, the vent hose can kink or partially collapse, impeding the functioning of the dryer. The space between the dryer and the wall is often six or eight inches. Many persons find such a space objectionable, as it reduces space in the room and is visually less appealing.

There is thus a need for a dryer vent which overcomes the limitations of available methods of venting a dryer. Specifically, there is a need for a dryer vent which eliminates the need for a large space between the dryer and the wall, and which reduces the risk of kinking or partially blocking the dryer vent hose.

### SUMMARY OF THE INVENTION

It is an object of the present invention to provide an improved dryer vent.

According to one aspect of the invention, a pedestal dryer vent is provided. The exhaust air from the dryer is directed out of the bottom of the dryer and into the pedestal. Such an arrangement does not require a substantial space between the dryer and the wall. Such an arrangement also reduces the chance of blocking the dryer vent.

These and other aspects of the present invention are realized in an improved pedestal dryer vent as shown and described in the following figure and related description.

### BRIEF DESCRIPTION OF THE DRAWINGS

Various embodiments of the present invention are shown and described in reference to the numbered drawings wherein:

FIG. 1 shows a side view of dryer and vent known in the prior art; and

FIG. 2 shows a side view of a dryer and pedestal vent of the present invention.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

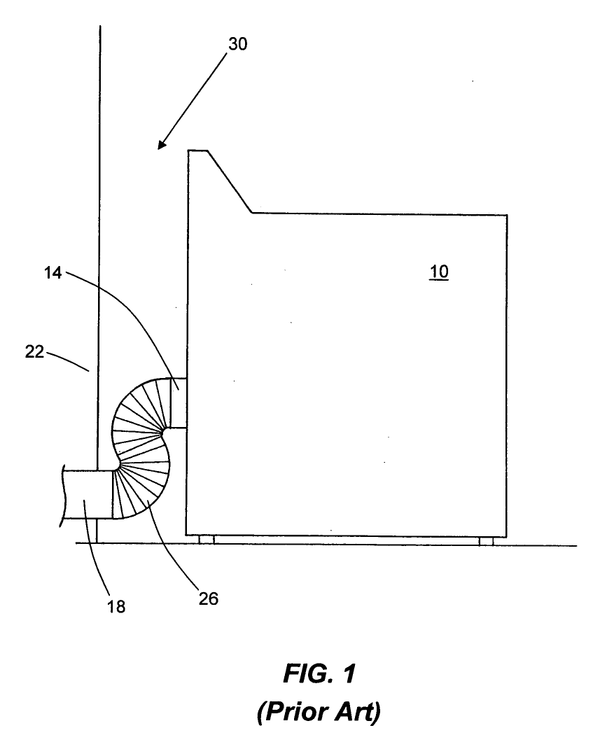

Turning now to FIG. 1, a side view of a dryer and vent known in the prior art is shown. The clothes dryer 10 is fitted with an exhaust outlet 14. The exhaust outlet 14 is typically found in the back of the dryer 10 somewhat near the bottom of the dryer. Houses typically include a dryer vent pipe 18 which is built into a wall 22 of the house. The dryer vent pipe 18 extends to the outside of the house, carrying the exhaust air from the dryer outside of the house. The dryer exhaust outlet 14 is typically connected to the dryer vent pipe 18 with a flexible hose 26. The flexible hose 26 is often constructed with a thin metal foil or metalized plastic film forming the hose and a metal spiral formed in the hose wall to support the hose and prevent collapse of the hose.

It is desirable to remove the dryer exhaust from the house for several reasons. The dryer exhaust air is hot and humid, and would often make a house or room too hot or humid. Additionally, the exhaust air contains an amount of lint which is not caught by the dryer lint trap. It is undesirable that the lint is vented into the room.

In connecting the dryer exhaust outlet 14 to the dryer vent pipe 18, the dryer is positioned a few feet away from the wall so as to allow a person to connect the flexible hose 26 to the exhaust outlet and vent pipe. Thus, a few feet of flexible hose 26 is needed. The dryer 10 is then moved back towards the wall 22. In positioning the dryer 10, some space 30 must be maintained between the dryer 10 and the wall 22. This space is typically about six inches or more. Such an amount of space is necessary to provide proper positioning of the flexible hose 26.

The exhaust outlet 14 and vent pipe 18 are typically not aligned. Thus, sufficient space 30 must be left to allow for bends in the flexible hose 26, as well as for the length of the exhaust outlet 14 and vent pipe 18 protruding from the dryer 10 and wall 22, respectively. Even if the exhaust outlet 14 and vent pipe 18 were perfectly aligned, sufficient space 30 would be necessary to accommodate the lengths of the exhaust outlet and vent pipe and the collapsed length of the few feet of flexible hose 26.

If the dryer 10 is pushed too close to the wall 22, the flexible hose 26 may be partially or completely collapsed. An obstruction in the flexible hose 26 impedes the flow of exhaust air from the dryer 10, reducing the efficiency of the dryer and causing premature failure of the dryer. Worse still, an obstruction in the flexible hose 26 causes increased accumulation of lint at the obstruction. Accumulated lint further impedes the flow of air and presents a fire hazard.

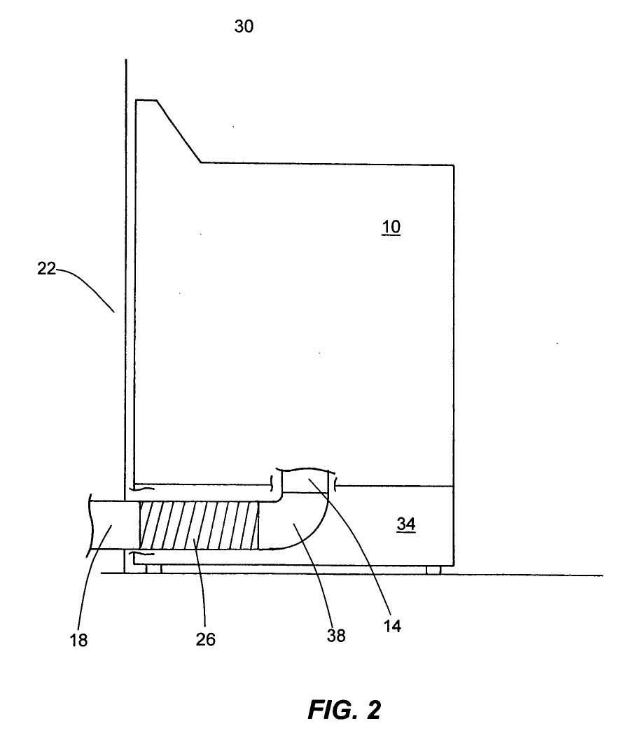

Turning now to FIG. 2, a side view of a dryer and pedestal dryer vent according to the present invention is shown. The dryer 10 has been placed on a pedestal 34. The pedestal 34 may be made to match the finish and appearance of the dryer 10 so as to present an attractive appearance. The pedestal 34 may be open on the top and back so as to provide access to the dryer 10 and wall 22. It will be appreciated by one of ordinary skill in the art that a prior art dryer can be configured to include pedestal features without the necessity of a separate pedestal component. This would be accomplished by elongating the body of the dryer 10 to provide pedestal-type space to a prior art configuration. These modified dryer configurations are contemplated in the invention disclosed herein.

The dryer exhaust outlet 14 has been directed out of the bottom of the dryer 10. Many dryers are capable of directing the exhaust vent out of the bottom of the dryer, but are vented out of the back as the dryer sits directly on the floor. The exhaust outlet 14 is connected to the vent pipe 18 with a flexible hose 26, and possibly utilizing an elbow fitting 38. An elbow fitting 38 is not necessary, but may be desirable as it helps ensure that the flexible hose 26 remains properly oriented towards the vent pipe 18 to the outside of the home when moving the dryer during installation. Ordinarily, the vent pipe 18 is located behind the dryer 10, but may also be located to either side or to the front of the dryer 10. The invention disclosed herein contemplates orienting the flexible hose 26 in any direction.

Sufficient space is provided between the elbow 38 or exhaust outlet 14 and the vent pipe 18 to accommodate the retracted length of the few feet of flexible hose 26 necessary to connect the exhaust outlet to the vent pipe. The flexible hose 26 is installed by positioning the dryer 10 far enough from the wall 22 to allow a person to connect the hose; typically a foot or two. After the flexible hose 26 is attached to the vent pipe 18 and to the exhaust outlet 14 or elbow 38, the dryer 10 is moved closer to the wall 22 as desired.

The configuration shown is advantageous for several reasons. The configuration shown is safer as it virtually eliminates the risk of a kinked or collapsed flexible hose 26. The distance between the vent pipe 18 and the elbow 38 or exhaust outlet 14 and the improved alignment between the same is such that the severity of the bends necessary in the flexible hose 26 is greatly reduced. Thus, the present invention reduces the risk that the flexible hose 26 is at least partially collapsed, with the resulting reduction in efficiency and accumulation of lint. Additionally, the present invention results in a more aesthetically pleasing dryer position, as the space 30 necessary between the dryer 10 and the wall 22 is virtually eliminated.

There are some situations where a dryer can not be vented to the outside of the house or building, such as in an apartment or house not fitted with a vent pipe. In such a situation, a compartment may be installed inside of the pedestal. Water is placed into the compartment, and the dryer exhaust air is directed into the compartment, either by blowing it at, across, or through the water. The water acts to both trap the lint and is evaporated by the warm air. When the water is gone, the compartment may be removed to clean out the lint and add new water. The compartment may be formed in or as part of a drawer so as to be easily removable for cleaning and servicing. The drawer could be removed or opened so as to provide easy access to the exhaust outlet 14 during installation, thus not requiring the dryer 10 to be positioned away from the wall 22.

There is thus disclosed an improved pedestal dryer vent. It will be appreciated that numerous changes may be made to the present invention without departing from the scope of the claims.

1-10. (canceled)

11. A dryer pedestal comprising:
a pedestal configured for receiving a clothes dryer thereon; and
a lint compartment for holding water, wherein the lint compartment receives exhaust air from the clothes dryer and traps dryer lint.

12. The dryer pedestal of claim 11, wherein the lint compartment is disposed within a drawer slideably located within the dryer pedestal.

13. The dryer pedestal of claim 12, wherein the drawer is removable from the pedestal for removing the dryer lint and adding new water to the lint compartment.

14. A method for exhausting air from a clothes dryer comprising:
placing a clothes dryer on top of a pedestal;
providing a lint compartment for holding water within the pedestal; and
directing exhaust air from the clothes dryer to the lint compartment whereby dryer lint is removed from the exhaust air.

15. The method of claim 14, wherein the exhaust air is vented into the room where the clothes dryer is located.
